(19) United States
(12) Patent Application Publication
(10) Pub. No.: US 2006/0020697 A1
(43) Pub. Date: Jan. 26, 2006

(54) System and method for presenting chat QoS indication to user

(75) Inventors: Scott Edwards Kelso, Durham, NC (US); Nathan J. Peterson, Raleigh, NC (US); Rod David Waltermann, Durham, NC (US); Arnold S. Weksler, Raleigh, NC (US); John Carl Mese JR., Cary, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/894,986

(22) Filed: Jul. 20, 2004

(51) Int. Cl. G06F 15/173

(52) U.S. Cl. 709/224

(57) ABSTRACT

Real time quality of service (QoS) of a link between Internet chat users is gathered and displayed to the users.

### FIELD OF THE INVENTION

The present invention relates generally to chat systems.

### BACKGROUND OF THE INVENTION

Various communication systems that use computer networks have appeared in recent years due to the expansion of the Internet. One of these is known as chat systems, operating using multi-user and real-time communication. These chat systems have become a convenient and efficient means of communication through the internet, providing alternatives to electronic mail and telephone services. In essence, “chat” can be thought of as “live email.” In other words, chat is a form of online messaging, an exchange of remarks, through a server or system that uses the internet.

A computer system communicating through a network via a server computer, running a software program enabling a user to chat with another computer user on the same network, may be referred to as a “chat client.” Users create a chat network, what is commonly referred to as a virtual space, by chatting through chat clients and the matching servers. In doing so, chat users establish a chat medium, or so-called channel, through which chat clients converse in real time via the common server. Therefore, a “chat system” is a communication system marked by chat client users that share a number of these virtual spaces.

As recognized by the present invention, there is no way to monitor or display the current real time quality of service (QoS) available in the chat system. The present invention understands that this real time quality of service is an important indicator of the general chat reliability of a chat client user and its messaging capabilities, as well as its file sharing capabilities, because information regarding the quality of service can be acted upon once it is determined that another user's connection is unreliable. As set forth further below, chat client users can change their connection type (i.e. wireless to wired) or defer chatting/file transferring until such time when the connection is deemed sufficiently reliable.

### SUMMARY OF THE INVENTION

A computer-implemented method includes establishing a communication link between first and second chat client computers to facilitate a chat session between the computers. An indication representing a real time quality of service (QoS) metric relating to the communication link is displayed at one or both clients.

In non-limiting embodiments the metric can be an aggregated QoS metric, or it can be link availability, data throughput, link error rate, or link latency. One of the chat clients can send a QoS test signal to another chat client to facilitate obtaining real time QoS information pertaining to the link. Alternatively, a chat server can ping chat clients to facilitate obtaining real time QoS information pertaining to the link. The information can be displayed using icons and/or alpha-numeric characters.

In another aspect, a service includes gathering, in real time, quality of service (QoS) information pertaining to a communication link having as one node a first chat client. The service also includes providing the QoS information to first chat client and/or to a Web server associated with the first chat client.

In another aspect, a computer system includes a chat client computer that receives real time quality of service (QoS) information relating to a chat link used by the chat client computer. An output device communicates with the chat client computer for displaying the QoS information.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a system for undertaking the present invention;

FIG. 2 is a flow chart of the logic for gathering real-time quality of service (QoS) information;

FIG. 3 is a flow chart of alternate logic for gathering real-time quality of service (QoS) information;

FIG. 4 is a flow chart of logic for presenting QoS information; and

FIG. 5 is a schematic diagram of an exemplary non-limiting user display of QoS information.

### DETAILED DESCRIPTION OF THE PREFERRED EMBODIMENT

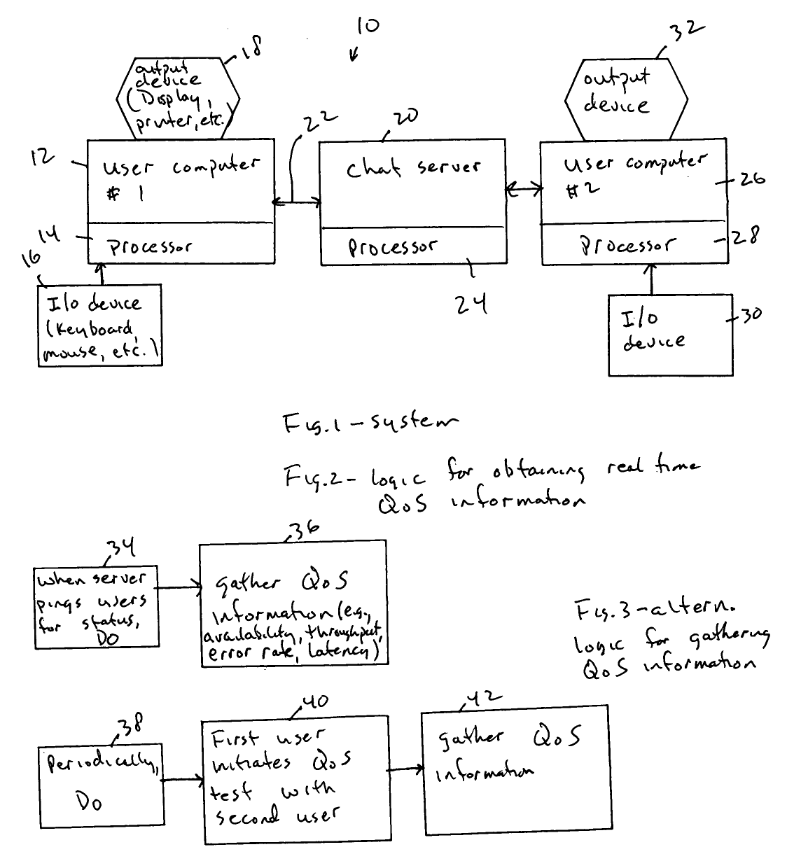

Referring initially to FIG. 1, a system is shown, generally designated 10, that includes a first chat client computer 12 having one or more processors 14 receiving user input from an input device 16, such as but not limited to one or more of a keyboard, mouse, keypad, voice recognition device, etc. The chat client computer 12 also has an output device 18 such as but not limited to one or more of a computer monitor, audio speaker, printer, computer, or computer network.

The first chat client computer 12 may communicate with a server 20 over a communication path 22 such as the Internet. In the embodiment shown, the server 20 is a chat server that includes one or more processors 24. In turn, the chat server 20 can communicate with a second chat client computer 26 that has a processor 28, input device 30, and output device 32.

It is to be understood that while only two chat client computers are shown, more client computers and more chat servers may be implemented in the present invention. The computers shown herein may be any suitable computers, e.g., personal computers, server computers, laptop computers, etc. It is to be further understood that at least portions of the inventive logic divulged herein may be executed by one or more of the processors shown in FIG. 1. Thus, the invention may be embodied as a computer-implemented method, a general purpose computer programmed to undertake the method, and a computer program product (i.e., an article of manufacture) such as a computer storage device that holds computer code such as but not limited to C++ or Java that embodies the present logic. The chat client computers 12, 26 may communicate with each other through the chat server 20 or may communicate directly with each other.

Now referring to FIG. 2, commencing at block 34 a DO loop can be entered when, for instance, the chat server 20 “pings” a user for status, i.e., when the chat server determines, by means of, e.g., status request messages, what the status is of the chat client. Proceeding to block 36, the information on the QoS of the server-client link is gathered at the chat server. This is done for each client. Then, when two clients are chatting, the chat server adds the metrics of each link to obtain the total QoS to present as discussed further below in reference to FIG. 4. The gathered QoS information may include link availability (e.g., “available” or “not available”), link data throughput in bits or bytes per second, link error rate in terms of number of errors per unit data or unit time, and link latency in term of average or peak time periods to convey a message or unit of data over the link.

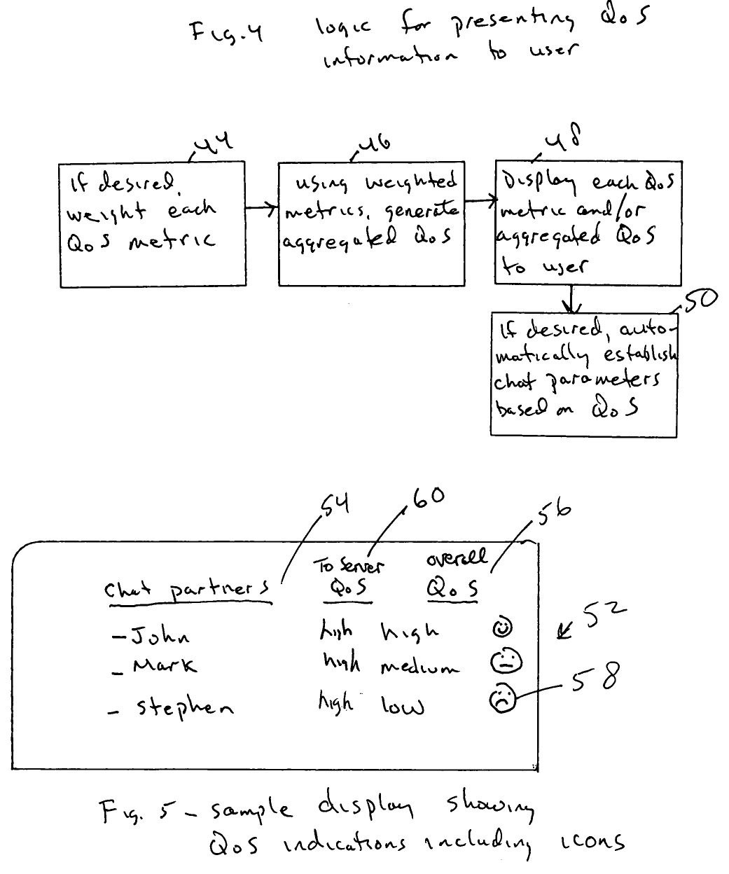

FIG. 3 shows an alternate method than that displayed in FIG. 2. The alternate method includes gathering QoS information for the entire path between one chat client to another. In essence, an end-to-end QoS is obtained by either client, at sign on and/or periodically thereafter. Block 38 shows the initiation of the process, wherein a DO loop can be entered periodically, causing the logic to flow to block 40. At block 40, the first chat client initiates a QoS test signal with the second chat client. Then, at block 42, the QoS information is gathered by the first chat client computer for the entire link between the clients, including the link between the initiating client and one or more intermediate servers. Through this method, information about the direct connection between two chat clients is gathered, as opposed to gathering QoS information at the chat server itself.

If desired, one or more chat servers that form the link between chat clients can maintain the QoS information, either by generating it themselves as shown in FIG. 2 or by requesting it or intercepting it as chat clients generate the information in accordance with FIG. 3. In any case, the QoS information may be used by a server or servers to optimize message routing between clients. For instance, a chat server might notice that the QoS between that chat server and a first relay server is poor for two particular clients, whereas the QoS between the chat server and a second relay server is good, in which case the chat server will relay chat messages between the clients using the second relay server.

Moving to FIG. 4, the logic for presenting QoS information that has been gathered through the methods prescribed in either FIG. 2 or FIG. 3 is shown. At block 44, a specific weight for each QoS metric can be given, if desired. An example would be to give QoS factor 1 a weight of 2, but QoS factors 2-4 may be given a weight of 4 if they are held as more significant by the chat server or chat client. Block 46 shows how, after all the weighted factors are added together, the sum of the weighted factors may be divided by 4 (the total amount of factors, not their individual weights) to achieve an aggregated QoS measurement. This aggregated measurement can be presented quantitatively as a number, or it can be correlated to a qualitative value such as “good,” “fair,” or “poor.” This qualitative description can be displayed to the chat client user. However, the data collected does not have to be aggregated into one QoS measurement, but the data may also be broken down into categories 1-4 above and displayed individually.

After the QoS measurement is generated, block 48 shows the user receiving a display of each QoS metric and/or aggregated QoS (quantitatively or qualitatively). If desired, at block 50 a chat client may automatically establish chat parameters based on the QoS. For instance, the chat client might automatically switch the chat link to another channel, e.g., it might switch from a wireless link to a wired link. As another example, the chat client might prohibit the transmission of certain documents or messages until link QoS is above a threshold.

It is to be understood that this QoS data display can initially occur at chat start, or it can occur some time thereafter. In a “push” the chat server notices the chat clients are chatting and sends the QoS information immediately to the two chat client users. In a “pull” a chat client computer, once it establishes a connection with another chat client computer, does one of two things. It either asks the server for QoS information if the method in FIG. 2 is being implemented, or it initiates its own QoS test signal through the process shown in FIG. 3. In either case, the QoS information is presented to the user and potentially acted upon automatically by the user's client computer as discussed above.

Referring to FIG. 5, a schematic diagram of an exemplary user display 52 of QoS information, including sample icons, is shown. FIG. 5 shows a list 54 of chat partners for a given chat client and the corresponding QoS ratings 56 for the overall link between the chat client viewing the display and a chat partner. Each of these corresponding QoS ratings can be shown with matching icons 58.

In addition to or in lieu of the end-to-end ratings 56, as shown by the QoS indication column 60 in FIG. 5 the QoS information displayed to a chat client may include an indication of the real-time QoS between the client and the chat server. In this way, the user can determine whether a QoS problem, if any, is system-wide or is caused simply by the connection between the user's computer and the user's chat server. For example, as shown in FIG. 5 the QoS between the chat client and its server is high, but for partner “Mark” the end-to-end QoS is medium and for partner “Stephen” the end-to-end QoS is low, indicating to the user that the QoS difficulties at least do not arise because of the link between the user's computer and the chat server.

It is to be understood that the monitoring and communicating of QoS data on display may be enabled/disabled for privacy by each client. When enabled, the information regarding the QoS data shown gathered in the process in FIG. 4, through the sample display shown in FIG. 5, would be displayed on an output device such as the output device 18 shown in FIG. 1.

The invention above can be provided as a service. For instance, the QoS information can be gathered by a service provider server, e.g., the server 20 shown in FIG. 1, and then provided, free or for a cost, to the chat client computers so that link QoS information is displayed for the users of the chat client computers.

While the particular SYSTEM AND METHOD FOR PRESENTING CHAT QoS INDICATION TO USER as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A computer-implemented method, comprising:
establishing a communication link between at least first and second chat client computers to facilitate a chat session between the computers; and
displaying, at at least one of the chat client computers, at least one indication representing at least one real time quality of service (QoS) metric relating to at least a portion of the communication link.

2. The method of claim 1, wherein the metric is an aggregated QoS metric.

3. The method of claim 1, wherein the metric is link availability.

4. The method of claim 1, wherein the metric is link data throughput.

5. The method of claim 1, wherein the metric is link error rate.

6. The method of claim 1, wherein the metric is link latency.

7. The method of claim 1, wherein the first chat client computer sends at least one QoS test signal to a second chat client computer to facilitate obtaining real time QoS information pertaining to the link.

8. The method of claim 1, wherein a chat server pings at least one chat client to facilitate obtaining real time QoS information pertaining to the link.

9. The service of claim 1, wherein the displaying act is undertaken using at least one icon.

10. The service of claim 1, wherein the displaying act is undertaken using alpha-numeric characters.

11. A service comprising:
gathering, in real time, quality of service (QoS) information pertaining to a communication link having as one node a first chat client; and
providing the QoS information to at least one of: the first chat client, and a Web server associated with the first chat client.

12. The service of claim 11, wherein the providing act facilitates display of the QoS information at the first chat client.

13. The service of claim 11, wherein the QoS information is aggregated from plural QoS metrics.

14. The service of claim 11, wherein the QoS information is at least one selected from the group consisting of: link availability, data throughput, link error rate, and link latency.

15. The service of claim 11, wherein the first chat client computer sends at least one QoS test signal to a second chat client computer to facilitate obtaining real time QoS information pertaining to the link.

16. The service of claim 11, wherein a chat server pings at least one chat client to facilitate obtaining real time QoS information.

17. A computer system, comprising:
at least one chat client computer programmed to receive real time quality of service (QoS) information relating to a chat link used by the chat client computer; and
at least one output device communicating with the chat client computer for displaying the QoS information.

18. The system of claim 17, comprising at least one chat server computer communicating with the chat client computer.

19. The system of claim 18, wherein the chat server computer gathers the QoS information and sends it to the chat client computer.

20. The system of claim 18, wherein the chat client computer initiates gathering of the QoS information.
